(19) United States
(12) Patent Application Publication
(10) Pub. No.: US 2002/0054288 A1
(43) Pub. Date: May 9, 2002

(54) Automatic water quality measurement system based on a high performance optical fiber probe

(76) Inventors: Dong Hwan Kim, Seoul (KR); Ick Tae Yeom, Seoul (KR); Kyu Hong Ahn, Seoul (KR); Yong Hun Lee, Seoul (KR)

Correspondence Address: BACON & THOMAS, PLLC, 625 Slaters Lane, 4th Floor, Alexandria, VA, 22314-1176, US

(21) Appl. No.: 09/774,623

(22) Filed: Feb. 1, 2001

(30) Foreign Application Priority Data
Sep. 21, 2000 (KR) 10-2000-55416

(51) Int. Cl. G01N 21/64

(52) U.S. Cl. 356/317; 250/461.1

(57) ABSTRACT

The present invention relates to a water quality measurement system based on a high performance optical fiber probe, and more particularly relates to a water quality measurement system based on a high performance optical fiber probe that immerses an optical fiber prove inducing an ultraviolet light into contaminated water distant from the measurement device, irradiates the light, collects the reflected fluorescent lights, and quantifies the contamination level using a spectrometer thereby.

The prior water quality measurement system has problems that it requires a periodical maintenance for nozzle cleaning due to the nozzle choking caused by the contaminants contained in contaminated water and it is impossible to measure the accurate contamination level of contaminated water having a low-contamination level due to the small amount of fluorescence.

The present invention presents a water quality measurement system that minimizes the maintenance procedures by immersing an optical probe into contaminated water only while an experiment is being carried out and soaking it into cleaning fluid while it is not being used, and enables to measure the accurate contamination level of contaminated water even in the case of a low contamination level by introducing a circular reflection mirror that increases the efficiency of detecting the fluorescent signals transmitting through the contaminated water.

### BACKGROUND OF THE INVENTION

1. Field of the Invention

The present invention relates to a water quality measurement system based on a high performance optical fiber probe, and more particularly relates to a water quality measurement system based on a high performance optical fiber probe that immerses an optical fiber prove inducing an ultraviolet light into contaminated water distant from the measurement device, irradiates the light, collects the reflected fluorescent lights, and quantifies the contamination level using a spectrometer thereby.

Recently, as the environmental contamination becomes to be highly concerned, the measurement technique of contamination level is developed to be more efficient. In other words, the environmental contamination had been measured by directly collecting a contaminated sample at a place where contaminated water exists such as a sewage treatment plant. However, the measurement technique is recently being changed to irradiate a light into contaminated water and measure the contamination level by using the amount of light that transmits through contaminated water.

A contamination measurement system, which measures the contamination level by using the amount of the residual light transmitting through contaminated water, is supposed to measure the accurate contamination level regardless of the contamination concentration level of contaminated water. And it is required for an accurate measurement of the contamination level to prevent the contaminant being adsorbed at an inlet pipe or a nozzle through which contaminated water incomes.

2. Description of the Related Art

Referring to an appended drawing, the prior contamination level measurement technique is described hereinafter.

FIG. 1 is a structural diagram illustrating the prior water quality measurement system that irradiates a light into the contaminated water falling through a nozzle and measures the contamination level by using the amount of light that transmits through the contaminated water.

It is not described in FIG. 1, however, the system is equipped with a pressure control pipe and an outlet pipe that control the water level of contaminated water to maintain a constant pressure to measure the accurate contamination level while the externally incoming contaminated water is falling through the fluid pipe(5).

In other words, it is constructed to be that the pressure control pipe controls the pressure to be constant, and in case that the pressure control pipe can no longer control the pressure to be constant and the pressure increases, and thereby the water level becomes high, a portion of contaminated water outlets through the outlet pipe so that the pressure remains to be constant.

As described in FIG. 1, while the externally incoming contaminated water is falling through a fluid pipe(5), a certain amount of light is produced at a lamp(1a) and irradiated to the direction of the falling water.

Here, the amount of the light emitted from the lamp(1a) is filtered by the third optical filter(6c) that transmits the light with a specific wavelength(visible light in this case), and the signal corresponding to the amount of the filtered light with a specific wavelength is transmitted through the third optical detector(7c) to the control section(8).

At the same time, the fourth optical filter(not described in the figure) filters the light with another specific wavelength(ultraviolet in this case) among the light emitted from the lamp(1a) and the fourth optical detector(not described in the figure) transmits the signal corresponding to the amount of the filtered light to the control section(8).

And a collecting lens(2) installed in front of the lamp(1a) collects the scattered lights to irradiate them to the falling contaminated water with a constant direction and a constant light flux.

The light irradiated into the falling water by the collecting lens(2) transmits through the water and incidents to the first receiving lens(3) located in front of the collecting lens(2).

Here, the incident light is the light that is not scattered by a contaminant, and the light that is scattered(scattered light) by contaminants(mainly oil components in this case) incidents to the second receiving lens(not described in the figure).

The first receiving lens(3) and the second receiving lens induce the incident lights to the first optical filter(6a) and the fourth optical filter(not described in the figure) installed at the back of the lens.

Here, the light induced at the first receiving lens(3) are branched, before being induced to the first optical filter(6a), by an optical distributor(4) so that half of the induced light is transmitted to the first optical filter(6a) and the other half of the light is reflected by 45° and induced to the second optical filter(6b).

The light transmitted through the optical distributor(4) to the first optical filter(6a) is filtered by the first optical filter(6a) and the light having yellow-colored wavelength(visible light in this case) is only transmitted to the control section(8) through the first optical detector(7a). And the light induced to the second optical filter(6b) by the optical distributor(4) is filtered by the second optical filter(6b) and the ultraviolet light, which is acceptable for the second optical filter(6b), is only transmitted to the control section(8) through the second optical detector(7b).

Here, the visible light of yellow-colored wavelength is used for measuring the degree of turbidity, and the ultraviolet light is used for the measurement of the nitrate concentration, the biological oxygen demand(BOD), and the chemical oxygen demand(COD) of contaminated water.

In addition, the light scattered by contaminated water incident to the second receiving lens is filtered by the fourth optical filter(not described in the figure), and the ultraviolet light is only transmitted to the control section(8) through the fourth optical detector(not described in the figure).

The control section(8) compares the signals transmitted from the first optical detector(7a), the second optical detector(7b) and the fourth optical detector(not described in the figure) with the prescribed values(values of uncontaminated water), and measures the contamination level thereby.

However, the prior water quality measurement system, that measures the contamination level by irradiating a light into contaminated water and using the amount of light that transmits through contaminated water, has a problem that it requires a periodical maintenance for nozzle cleaning because it is difficult to preserve a constant inlet pressure of contaminated water due to the nozzle choking caused by the contaminants contained in contaminated water.

In addition, the receiving part in the prior art adopts a single lens system to collect the light so that it collects only one directional fluorescent lights among the fluorescent lights emitted in all directions, and therefore the prior system has another problem that it is impossible to measure the accurate contamination level of contaminated water having a low contamination level due to the small amount of fluorescence. (Fluorescence occurs in proportion to the contamination level.)

### SUMMARY OF THE INVENTION

The present invention is proposed to solve the problems of the prior art mentioned above. It is therefore an object of the present invention to provide a water quality measurement system that minimizes the maintenance procedures required for the prior water quality measurement system by immersing an optical fiber probe, which is the part that directly contacts with contaminated water, in contaminated water only while an experiment is being carried out and soaking it in the cleaning fluid while it is not being used, and thereby eliminating the procedure of cleaning the measurement system.

And, as mentioned above, the prior art has another problem that it is impossible to measure the accurate contamination level of the contaminated water having a low contamination level due to the small amount of fluorescence received at receiving lens.

It is therefore another object of the present invention to provide a water quality measurement system that enables to measure the accurate contamination level of the contaminated water even in the case of low-level contamination by introducing a circular reflection mirror that increases the detection efficiency of the fluorescent signals transmitting through the contaminated water.

To achieve the objects mentioned above, the present invention presents a water quality measurement system based on a high performance optical fiber probe comprising: a cleaning section that cleans an optical fiber probe to remove the contaminants stuck to it after each contamination measurement by using a solvent and a sodium-hydrate solution for an accurate measurement of contaminated water having a low contamination level; an actuation section that actuates the cleaned optical fiber probe using a linear motor and immerses it into contaminated water down to a certain depth; a light emitting lamp that emits an ultraviolet light; an optical fiber probe that irradiates the ultraviolet light emitted from the light emitting lamp into the contaminated water contacting to the end of the optical fiber probe through a fiber optical distributor and collects the fluorescent signals generated in the water by the irradiation using a circular reflection mirror to maximize the collection; a fiber optical distributor that receives the fluorescent signals collected by the optical fiber probe and transmits 50% of the signals to a spectrometer; a spectrometer that disperses the fluorescent signals transmitted from the fiber optical distributor into the analyzed signals with specific wavelengths using a spectroscope and transmits the analyzed signals to a control section; and a control section that calculates the contamination level by following a calculation algorithm using the analyzed signals transmitted from the spectrometer and calibrating constants, displays the calculated contamination measurement results, and controls the operation of the actuation section.

### BRIEF DESCRIPTION OF THE DRAWINGS

FIG. 1 is a structural diagram illustrating a prior water quality measurement system that irradiates a light into contaminated water falling through a nozzle and measures the contamination level by using the amount of light that transmits through the contaminated water.

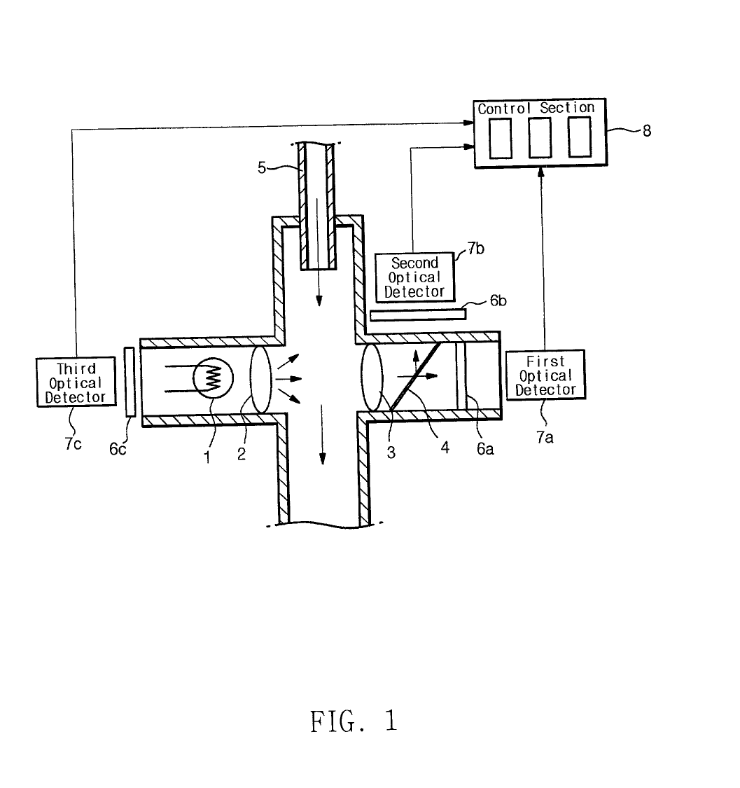

FIG. 2 is a structural diagram illustrating a water quality measurement system based on a high performance optical fiber probe in accordance with the present invention.

FIG. 3a and 3b are graphs comparing the experimental results of water quality measurements under various conditions using an embodiment of the present invention.

### DESCRIPTION OF THE NUMERICS ON THE MAIN PARTS OF THE DRAWINGS

1: a lamp

2: a collecting lens

3: the first receiving lens

4: an optical distributor

5: a fluid pipe

6a: the first optical filter

6b: the second optical filter

6c: the third optical filter

7a: the first optical detector

7b: the second optical detector

7c: the third optical detector

8a, 8b: a control section

9: an optical fiber probe

10: a fiber optical distributor

11: a spectrometer

12: a display section

13: a cleaning section

14: contaminated water

15: a light emitting lamp

16: a circular reflection mirror

17: an optical fiber clad

18: an optical fiber core

19: a probe holding bar

20: a probe holder

### DETAILED DESCRIPTION OF THE EMBODIMENTS

Hereinafter, referring to appended drawings, the structure and the operation procedures of an embodiment of the present invention are described in detail.

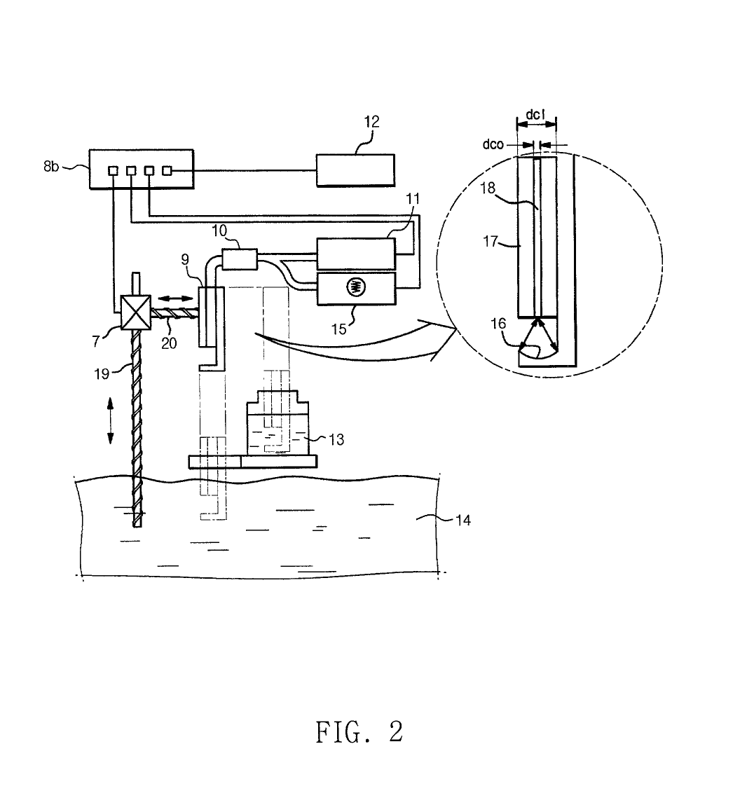

FIG. 2 is a structural diagram illustrating a water quality measurement system based on a high performance optical fiber probe in accordance with the present invention.

As described in FIG. 2, for measuring the contamination level of contaminated water(14), one first immerses an optical fiber probe(9) into contaminated water(14) down to a certain depth by using a spiral-shaped probe holding bar(19) equipped in the actuation section(7) that includes a linear motor(not described in the figure).

The optical fiber probe(9), which is soaked into contaminated water(14) down to a certain depth, is fixed by a spiral-shaped probe holder(20) connected to the actuation section(7), and the probe holder(20) moves in horizontal direction, which is perpendicular to the probe holding bar(17), to control the optical fiber probe to be located in contaminated water(14) or in the cleaning section(13).

Here, the connecting section between the optical fiber probe(9) and the fiber optical distributor(10) is manufactured of a flexible rubber-element or the like for an easy movement of the optical fiber probe(9).

And the operation of the actuation section(7) is controlled by the control section(8b) that controls overall operation of the measuring system.

After immersing the optical fiber probe(9) into contaminated water(14) down to a certain depth, a light emitting lamp(15) irradiates a light having a specific wavelength(an ultraviolet light) to contaminated water(14) through the optical fiber probe(9).

Fluorescent signals are generated by the irradiation of lights to the contaminated water(14), and the generated fluorescent signals transmit the contaminated water(14), reflect at a circular reflection mirror(16), and incident back to the optical fiber probe(9).

Here, the curvature(R) of the circular reflection mirror(16) to collect the maximum amount of the generated fluorescent signals can be obtained by the following calculations.

First, the numerical aperture of the end of the optical fiber probe(9) is calculated by the following equation:

[Equation 1]

N.A.−nᵤ\sqrt{n_{co}²−n_{cl}²},

where,

N.A.: numerical aperture of the end of the optical fiber probe,

nᵤ: refraction index of contaminated water,

n_{co}: refraction index of optical fiber core,

n_{cl}: refraction index of optical fiber clad.

And, the maximum angle for fluorescent signals generated in contaminated water(14) to be guided to the optical fiber probe is calculated by the following equation:

[Equation 2]

$$sin {θ}_{max} = \frac{\sqrt{{n}_{co}^{2} - {n}_{cl}^{2}}}{{n}_{u}} .$$

Here, the value of sinθₘₐₓ can be expressed by another equation(Eqn.3) using the diameter of the optical fiber core(l8) and the curvature(R) of the circular reflection mirror(16):

[Equation 3]

$$sin {θ}_{max} = \frac{{d}_{co}}{\sqrt{{n}_{co}^{2} - {n}_{cl}^{2}}} ,$$

where,

d_{co}: diameter of optical fiber core,

n_{co}: refraction index of optical fiber core,

n_{cl}: refraction index of optical fiber clad.

Now, by using Equation 2 and Equation 3, the curvature(R) of the circular reflection mirror(16) to collect the maximum amount of the fluorescent signals generated in contaminated water can be calculated by the following equation:

[Equation 4]

$$R = {d}_{co} \sqrt{\frac{{n}_{u}}{\sqrt{{n}_{co}^{2} - {n}_{cl}^{2}}} - 1} ,$$

where,

R: curvature of the circular reflection mirror,

d_{co}: diameter of optical fiber core,

nᵤ: refraction index of contaminated water,

n_{co}: refraction index of optical fiber core,

n_{cl}: refraction index of optical fiber clad.

And, for comparing the amounts of fluorescent signals collected by a planar reflection mirror and a circular reflection mirror by using their volumes, the volume(V₁) obtained by rotating the sector area of the circular reflection mirror(16) of the present invention can be calculated by the following equation:

[Equation 5]

$${V}_{1} = \frac{1}{3} π {R}^{3} {tan}^{2} {θ}_{max} ,$$

where,

R: curvature of the circular reflection mirror,

d_{co}: diameter of optical fiber core,

θₘₐₓ: maximum angle for a fluorescent signal to be guided to the optical fiber.

And, the volume(V₂) obtained by rotating the rectangular area of a prior planar reflection mirror can be calculated by the following equation:

[Equation 6]

$${V}_{2} = \frac{1}{4} {θ}_{max} {d}_{co}^{2} ,$$

where,

d_{co}: diameter of optical fiber core,

θₘₐₓ: maximum angle for a fluorescent signal to be guided to the optical fiber.

Here, since the reflecting amount is different from the transmitting amount by about factor of 2, by comparing V₁ and V₂ calculated from Equation 5 and Equation 6, it can be noticed that the amount of collected fluorescent signals is increased by about

$$\frac{8}{3} \frac{{R}^{2}}{{d}_{co}^{2}} {tan}^{2} {θ}_{max} .$$

The fluorescent signals incident to the optical fiber probe(9) are transmitted to the fiber optical distributor(10), and the fiber optical distributor(10) transmits only 50% of the transmitted fluorescent signals into the spectrometer(11).

The fluorescent signals transmitted to the spectrometer(11) is dispersed, by a spectroscope(not described in the figure) equipped in the spectrometer(11), into specific fluorescent wavelengths, corresponding to specific contamination indexes, by an optical dispersion element(not described in the figure), and the fluorescent signals dispersed into specific wavelengths are detected by a location-sensitive detector(not described in the figure) for measuring the contaminant for each wavelength.

In other words, in case of chemical oxygen demand(COD) among the detected contaminants by dispersed wavelengths, if the exciting wavelength(wavelength of the fluorescent signal incident to the spectrometer) is 266 nm, the emission wavelength(wavelength of the fluorescent signal dispersed by the optical dispersion element) is around 345 nm. And for floating material, if the exciting wavelength is 633 nm, the emission wavelength is 637 nm, and for chlorophyll-a, if the exciting wavelength is 440 nm, the emission wavelength is measured at 685 nm.

The analyzed signals dispersed into the specific wavelengths are transmitted to the control section(8b).

The control section(8b) carries out a calculation process using the transmitted analyzed signals dispersed into the specific wavelengths and the calibration constants proportional to the signals.

After the calculation, the contamination measurement signals are produced in the control section(8b) and transmitted to the display section(12) and displayed thereon.

The sequential procedures of contamination measurement experiment is ended by contamination measurement signals being displayed on the display section(12), and the actuation section(7) actuates the optical fiber probe(9) to be soaked into the cleaning fluid filled in the cleaning section(13).

Here, the reason for soaking the optical fiber probe(9) into the cleaning fluid is to prevent the contact point of the optical fiber probe(9) to contaminated water(14) being choked by contaminants due to repeated water quality measurements and carry out an accurate contamination measurement thereby.

The materials used for the cleaning fluid are solvent(methanol, ethanol, acetone, etc.) and sodium-hydrate solution, or acid solutions such as a hypochlorous acid solution.

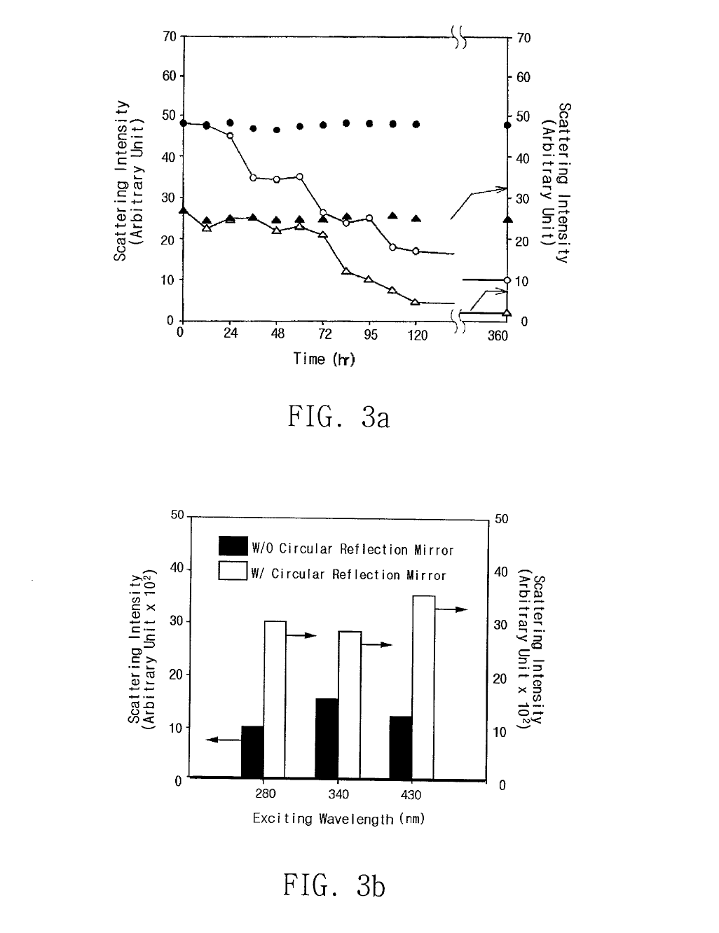

FIG. 3a and 3b are graphs comparing the experimental results of water quality measurements under various conditions using an embodiment of the present invention.

As shown in the figures, FIG. 3a is a graph comparing the scattering intensities(Y-axis) along with time(X-axis) with/without using a cleaning fluid for measuring the qualities of treatment water of the sewage treatment plant(indicated by ← and Δ) and ground water in a swamp or a lake(indicated by ● and ∘).

In the case of ground water, indicated by ● and ∘, indicates the case in which the optical fiber probe(9) is immersed into contaminated water only when the contamination measurement is being carried out and soaked into cleaning fluid when it is not being used.

∘ indicates the case in which the optical fiber probe(9) is soaked into contaminated water even when it is not being used for contamination measurement.

Looking into the comparing results, it is noticed that an initial scattering intensity remains constant even after 360 hours of measurement in the case of the optical fiber probe(9) being soaked into cleaning fluid when it is not being used for the measurement. On the other hand, the scattering intensity rapidly decreases after 72 hours of measurement in the case of the optical fiber probe(9) being soaked into contaminated water even when it is not being used for the measurement.

In particular, in the case of measuring the quality of treatment water of the sewage treatment plant, it is noticed that an initial scattering intensity remains constant even after 360 hours of measurement in the case of the optical fiber probe(9) being immersed into contaminated water only when the measurement being carried out and being soaked into cleaning fluid when it is not being used for the measurement(indicated by ▴). On the other hand, the scattering intensity rapidly decreases only after 24 hours of measurement in the case of the optical fiber probe(9) being soaked into contaminated water even when it is not being used for the measurement(indicated by Δ).

As shown in the comparison results, the decrease of scattering intensity is caused by adsorption of contaminants to the contact point(contaminated water providing pipe, nozzle, etc.) of the system that directly contacts with contaminated water. Therefore, for an accurate measurement of the contamination level, it is required for the prior measurement system to clean the contact point, that directly contacts with contaminated water, very often. On the other hand, a water quality measurement system in accordance with the present invention does seldom require an extra cleaning so that the maintenance of the system is relatively easy for being applied to a real-time automatic water quality measurement.

FIG. 3b is a graph comparing the scattering intensities at irradiation/detection wavelengths(here, for exciting wavelengths of 280 nm, 340 nm, 430 nm) for the cases of using a circular reflection mirror and not using a circular reflection mirror.

The black bars indicate the scattering intensities(Y-axis) at corresponding detection wavelengths(X-axis) for the case in which the light is irradiated by an optical fiber probe(9) toward contaminated water and the optical fiber probe(9) detects the fluorescent signals generated by the irradiation without using a circular reflection mirror.

And, the white bars indicate the scattering intensities(Y-axis) at corresponding detection wavelengths(X-axis) for the case in which the light is irradiated by an optical fiber probe(9) toward contaminated water and the optical fiber probe(9) detects the fluorescent signals generated by the irradiation by using a circular reflection mirror(14).

Comparing the results shown in FIG. 3b, it is noticed that the scattering intensities at corresponding detection wavelengths of the measurement system using a circular reflection mirror(14) are about 2˜3 times in log-scale(i.e., 100˜1000 times) higher, on the average, than those of the measurement system not using a circular reflection mirror(14).

In other words, a water quality measurement system using a circular reflection mirror(14) improves the efficiency of an optical fiber probe(9) for detecting the fluorescent signals generated by the irradiation by about 100˜1000 times, and the system therefore enables to perform an accurate water quality measurement even in the case of contaminated water having a low contamination level.

As mentioned thereinbefore, the present invention provides a water quality measurement system having the following advantageous characteristics:

First, by immersing an optical fiber probe, which is the part that directly contacts with contaminated water, into contaminated water only while an experiment is being carried out and soaking it in cleaning fluid while it is not being used, and thereby eliminating the procedure of cleaning the measurement system, the water quality measurement system of the present invention is easy to be maintained.

And second, by equipping a circular reflection mirror that improves the efficiency of detecting the fluorescent signals transmitting through contaminated water, the water quality measurement system of the present invention enables to perform an accurate water quality measurement even in the case of contaminated water having a low contamination level.

Since those having ordinary knowledge and skill in the art of the present invention will recognize additional modifications and applications within the scope thereof, the present invention is not limited to the embodiments and drawings described above.

What is claimed is:

1. A water quality measurement system based on a high performance optical fiber probe, that measures the contamination level of contaminated water by irradiating a light into contaminated water and detecting the fluorescent signals generated by the irradiation, comprising:
a cleaning section that cleans an optical fiber probe after each water quality measurement;
an actuation section that immerses said cleaned optical fiber probe into contaminated water down to a certain depth;
a light emitting lamp that emits a light having a specific wavelength;
an optical fiber probe that irradiates said light emitted from said light emitting lamp into contaminated water contacting to the end of the optical fiber probe through a fiber optical distributor and collects the fluorescent signals generated in the water by the irradiation;
a fiber optical distributor that receives the fluorescent signals collected by said optical fiber probe and transmits 50% of the signals to a spectrometer;
a spectrometer that disperses the fluorescent signals transmitted from said fiber optical distributor into analyzed signals with specific wavelengths using a spectroscope and transmits the analyzed signals to a control section; and
a control section that calculates the contamination level by following a calculation algorithm using the analyzed signals transmitted from said spectrometer and calibrating constants, displays the calculated contamination measurement results, and controls the operation of said actuation section.

2. A water quality measurement system based on a high performance optical fiber probe as claimed in claim 1,
wherein said light having a specific wavelength emitted from said light emitting lamp is an ultraviolet-light.

3. A water quality measurement system based on a high performance optical fiber probe as claimed in claim 1,
wherein said optical fiber probe is equipped with a circular reflection mirror.

4. A water quality measurement system based on a high performance optical fiber probe as claimed in claim 3,
wherein said circular reflection mirror equipped in said optical fiber probe is, for maximizing the collecting amount of fluorescent signals, characterized by the following equation:
[Equation 7]
$$R = {d}_{co} \sqrt{\frac{{n}_{u}}{\sqrt{{n}_{co}^{2} - {n}_{cl}^{2}}} - 1} ,$$
where,
R: curvature of the circular reflection mirror,
d_{co}: diameter of optical fiber core,
nᵤ: refraction index of contaminated water,
n_{co}: refraction index of optical fiber core,
n_{cl}: refraction index of optical fiber clad.
